(19) United States
(12) Patent Application Publication
(10) Pub. No.: US 2009/0198878 A1
(43) Pub. Date: Aug. 6, 2009

(54) INFORMATION PROCESSING SYSTEM AND INFORMATION PROCESSING METHOD

(76) Inventors: Shinji NISHIHARA, Kanagawa (JP); Eiji NAGATA, Kanagawa (JP)

Correspondence Address: MCDERMOTT WILL & EMERY LLP, 600 13TH STREET, NW, WASHINGTON, DC, 20005-3096, US

(21) Appl. No.: 12/363,940

(22) Filed: Feb. 2, 2009

(30) Foreign Application Priority Data
Feb. 5, 2008 (JP) P.2008-025280

(51) Int. Cl. G06F 12/02

(52) U.S. Cl. 711/103; 711/E12.008

(57) ABSTRACT

The information processing system is comprised of: a first nonvolatile storage device in which a plurality of first programs for initiating the information processing system, and duplications of the plural first programs have been stored in blocks different from each other; a second volatile storage device to which the plurality of first programs are transferred; a third nonvolatile storage device into which a second program for executing the plural first programs is stored; and a CPU (Central Processing Unit) for executing the plural first programs. While an instruction has been contained in the second program, the instruction instructs that the plurality of first programs are transferred from the first storage device to the second storage device, contents of the plurality of first programs transferred to the second storage devices are compared with each other; and if the contents of the plurality of first programs are not made coincident with each other, then a normal program is judged from the plurality of first programs based upon a majority decision. The CPU executes the first program judged as the normal program so as to initially initiate the information processing system.

### BACKGROUND OF THE INVENTION

1. Field of the Invention

The present invention is related to an information processing system containing a nonvolatile memory device, and related to an information processing method.

2. Description of the Related Art

NOR type flash memories and NAND type flash memories have been widely popularized. The NAND type flash memories have such a merit that integration degrees thereof are high and bit unit cost thereof is low, as compared with those of the above-described NOR type flash memories. On the other hand, the NAND type flash memories have such a demerit with respect to reliability of data: That is, a NAND type flash memory has a certain possibility that failure blocks may occur in which data cannot be correctly read/written under congenital and postnatal environments, and further has some possibilities that bit errors may occur due to a long term use. As a consequence, these NAND type flash memories have been mainly utilized as memories for data areas, but not been utilized as memories for program areas which require high reliability.

However, very recently, in order to construct systems in lower cost while effectively utilizing merits of NAND type flash memories, data higher reliability realizing techniques capable of using NAND type flash memories as program storage areas have been proposed in the technical field. In the above-described techniques, CPUs transfer programs for initially initiating systems from NAND type flash memories to random-accessible storage devices so as to execute the programs.

With respect to the problems contained in the data reliability of the NAND type flash memories, failure block information is stored in either externally provided nonvolatile storage devices or the NAND type flash memories in a multiplexing manner in order to improve reliability as to the failures block information (refer to patent publication 1). Also, with respect to the bit error aspect, the error detecting process operation and the error correcting process operation with employment of the check codes are carried out so as to improve the data reliability (refer to patent publication 2 and patent publication 3).

Patent Publication 1: JP-A-2006-277395

Patent Publication 2: JP-A-2005-190201

Patent Publication 3: JP-A-2006-323739

However, in accordance with the method described in the patent publication 1, although it is possible to avoid that the CPU initially initiates the system from the failure block, the bit error cannot be avoided. Also, in the method described in either the patent publication 2 or the patent publication 3, the instruction for performing the error correction must be contained in the loader program by which the CPU reads out the data from the NAND type flash memory. When the system is initially initiated, the file system for executing the error correction and the data management of the NAND type flash memory has not yet been initiated, but also, if the error correction is carried out during the initial initiation, then the initiating time becomes long. As a result, the following idea is not a realistic solution: That is, an instruction for performing an error correction is contained in the loader program by which the CPU reads out the data from the NAND type flash memory.

Moreover, there are many opportunities that a loader program is designed by an unchangeable mask ROM. Therefore, there are some possibilities that when a generation of a NAND type flash memory is changed, the previously designed loader program cannot be properly adapted thereto.

### SUMMARY OF THE INVENTION

An object of the present invention is to provide an information processing system and an information processing method, which can firmly perform an initial initiation thereof based upon data stored in a nonvolatile storage device.

The present invention is to provide an information processing system comprising: a first nonvolatile storage device in which a plurality of first programs for initiating the information processing system, and duplications of the plural first programs have been stored in blocks different from each other; a second volatile storage device to which the plurality of first programs are transferred; a third nonvolatile storage device into which a second program for executing the plural first programs is stored; and a CPU for executing the plural first programs.

In the above-described information processing system, an instruction has been contained in the second program, while the instruction instructs that the plurality of first programs are transferred from the first storage device to the second storage device, contents of the plurality of first programs transferred to the second storage devices are compared with each other; and if the contents of the plurality of first programs are not made coincident with each other, then a normal program is judged from the plurality of first programs based upon a majority decision; and the CPU executes the first program judged as the normal program so as to initially initiate the information processing system.

In the above-described information processing system, a judging value for determining a total number at which the contents of the plurality of first programs are compared with each other has been contained in the first program; and the CPU executes the instruction in accordance with the judging value.

In the above-described information processing system, in such a case that an area where either one of the first programs or a duplication of one of the first programs has been stored is a failure block in the first storage device, the program stored in such an area including the failure block is not employed in the comparisons of the contents of the plurality of first programs.

In the above-described information processing system, when one of the first programs is updated, an update program for one of the first programs is overwritten in the area where one of the first programs has been stored, and also, a duplication of the update program is overwritten in the area where the duplication of one of the first programs has been stored; and in such a case that a failure block is present in the area where either one of the first programs or the duplication of one of the first programs has been stored, either the update program or the duplication of the update program is written in a previously prepared spare area of the first storage device.

In the above-described information processing system, after the CPU could succeed in an execution of the first programs, the CPU overwrites data judged as the normal data in such an area judged as an error area at a place where the content of the plurality of first programs are not made coincident with each other.

The present invention is to provide an information processing system comprising: a first nonvolatile storage device in which a plurality of first programs for initiating the information processing system, and duplications of the plural first programs have been stored in blocks different from each other; a second volatile storage device to which the plurality of first programs are transferred; a third nonvolatile storage device into which a second program for executing the plural first programs is stored; a CPU for executing the plural first programs and the second program; and a program correcting circuit for correcting an error of the first programs.

In the above-described information processing system, the program correcting circuit compares contents of the plurality of first programs transferred to the second storage device with each other; when the contents of the plurality of first programs are not made coincident with each other, the program correcting circuit judges a normal program among the plurality of first programs based upon a majority decision; and the program correcting circuit rewrites such a first program judged as the normal program in the second storage device.

In the above-described information processing system, an instruction has been contained in the second program, while the instruction instructs that the plurality of first programs are transferred from the first storage device to the second storage device so as to initiate the program correcting circuit; and the CPU executes the first program judged as the normal program by the program correcting circuit so as to initially initiate the information processing system.

In the above-described information processing system, a judging value for determining a total number at which the contents of sid plurality of first programs are compared with each other has been contained in the first programs; the CPU executes the instruction in accordance with the judging value; and the program correcting circuit compares the contents of the plurality of first programs with each other and judges the normal program based upon the majority decision in accordance with the judging value.

In the above-described information processing system, in such a case that an area where either one of the first programs or a duplication of one of the first programs has been stored is a failure block in the first storage device, the program stored in such an area including the failure block is not employed in the comparisons of the contents of the plurality of first programs.

In the above-described information processing system, when one of the first programs is updated, an update program for one of the first programs is overwritten in the area where one of the first programs has been stored, and also, a duplication of the update program is overwritten in the area where the duplication of one of the first programs has been stored; and in such a case that a failure block is present in the area where either one of the first programs or the duplication of one of the first programs has been stored, either the update program or the duplication of the update program is written in a previously prepared spare area of the first storage device.

In the above-described information processing system, after the CPU could succeed in an execution of the first programs, the CPU overwrites data judged as normal data in such an area judged as an error area at a place where the content of the plurality of first programs are not made coincident with each other.

The present invention is to provide such an information processing method which is executed by an information processing system comprising a CPU and a nonvolatile storage device for storing thereinto initiation time information of the information processing system; in which: the CPU updates the initiation time information while the information processing system is initiated; and also when the initiation time exceeds a designated threshold value, the CPU overwrites the same contents stored in the nonvolatile storage device.

In the above-described information processing method, the content which has been stored in the nonvolatile storage device is a program which is executed by the CPU.

In the above-described information processing method, the initiation time information is initiating time information of the information processing system.

In the above-described information processing method, the initiation time information is an actual time during which the information processing system is being initiated.

The present invention is to provide such an information processing method of an information processing system comprising: a CPU, a nonvolatile storage device for storing thereinto initiation time information of the information processing system, and notifying means for notifying an execution of refreshing a program with respect to a user who uses the information processing system; in which: in such a case that the user issues a permission with respect to the notification notified by the notifying means, the CPU updates the initiation time information while the information processing system is initiated; and also, when the initiation time exceeds a designated threshold value, the CPU overwrites the same contents stored in the nonvolatile storage device.

In the above-described information processing method, the content which has been stored in the nonvolatile storage device is a program which is executed by the CPU.

In the above-described information processing method, the initiation time information is initiating time information of the information processing system.

In the above-described information processing method, the initiation time information is an actual time during which the information processing system is being initiated.

In accordance with the information processing system and the information processing method related to the present invention, the initial initiation can be firmly carried out based upon the data stored in the nonvolatile storage device. Also, since the bit error can be corrected in a simple manner, the information processing system and the information processing method can be properly operated even when the generation of the nonvolatile storage device is changed. In addition, the occurrence frequency of the bit errors can be suppressed, so that the initial initiation time of the system can be shortened.

### BRIEF DESCRIPTION OF THE DRAWINGS

FIG. 1 is a block diagram for showing an information processing system according to a first embodiment mode of the present invention.

FIG. 2 is a diagram for indicating an arranging example of programs that are stored in a first storage device 110 of the first embodiment mode.

FIG. 3 is a flow chart for describing process operation of a CPU related to a system initial initiation of the first embodiment mode.

FIG. 4 is a block diagram for showing an information processing system according to a second embodiment mode of the present invention.

FIG. 5 is a diagram for indicating an arranging example of programs that are stored in a first storage device 110 of the second embodiment mode.

FIG. 6 is a flow chart for describing process operation of a CPU related to a system initial initiation of the second embodiment mode.

FIG. 7 is a flow chart for describing process operation of the CPU when a failure block is present in the flow chart shown in FIG. 6.

FIG. 8 is a block diagram for showing an information processing system according to a third embodiment mode of the present invention.

FIG. 9 is a flow chart for describing process operation of a CPU when the CPU updates a first program group in the third embodiment mode.

FIG. 10 is a block diagram for showing an information processing system according to a fourth embodiment mode of the present invention.

FIG. 11 is a diagram for indicating an arranging example of programs which are stored in a first storage device 110 of the fourth embodiment mode.

FIG. 12 is a block diagram for representing a program correcting circuit 201 of the fourth embodiment mode.

FIG. 13 is a flow chart for describing respective process operations of a CPU and the program correcting circuit 201 related to a system initial initiation of the fourth embodiment mode.

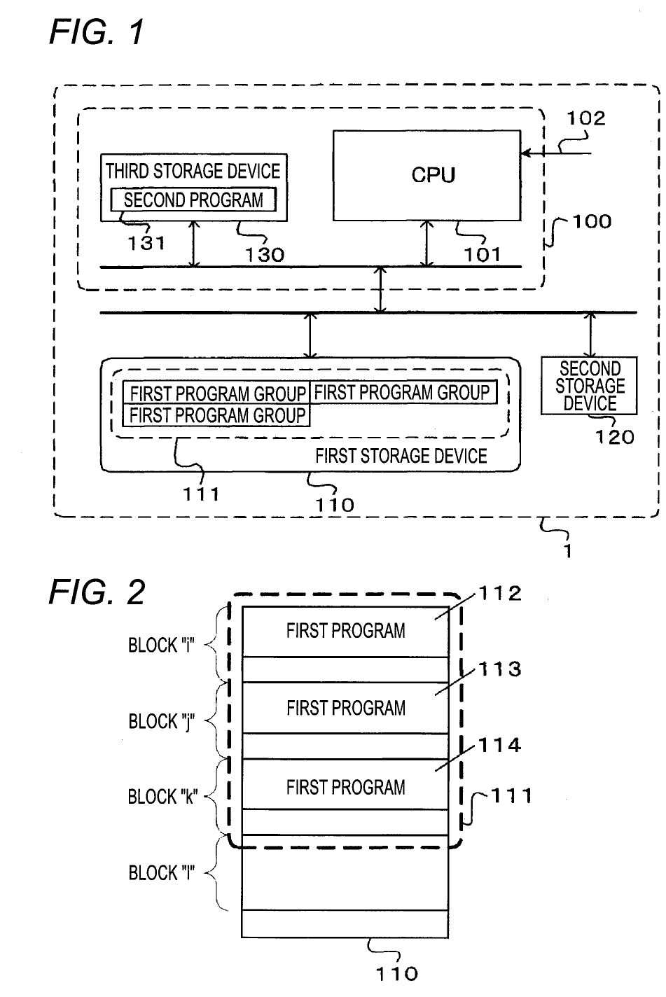

FIG. 1 is a block diagram for showing an information processing system according to a fifth embodiment mode of the present invention.

FIG. 15 is a flow chart for describing respective process operations of a CPU and the program correcting circuit 201 related to a system initial initiation of the fifth embodiment mode.

FIG. 16 is a flow chart for describing process operations of the CPU and the program correcting circuit when a failure block is present in the flow chart shown in FIG. 15.

FIG. 17 is a block diagram for indicating an information processing system according to a sixth embodiment mode of the present invention.

FIG. 18 is a block diagram for indicating an information processing system according to a seventh embodiment mode of the present invention.

FIG. 19 is a flow chart for describing information processing operation executed by the information processing system of the seventh embodiment mode.

FIG. 20 is a flow chart for indicating a different information processing operation executed by the information processing system of the seventh embodiment mode.

FIG. 21 is a block diagram for indicating an information processing system according to an eighth embodiment mode of the present invention.

FIG. 22 is a flow chart for describing information processing operation executed by the information processing system of the eighth embodiment mode.

FIG. 23 is a flow chart for describing information processing operation executed by the information processing system of the eighth embodiment mode.

FIG. 24 is a flow chart for describing information processing operation executed by the information processing system of the eighth embodiment mode.

FIG. 25 is a flow chart for describing information processing operation executed by the information processing system of the eighth embodiment mode.

FIG. 26 is a block diagram for indicating an information processing system according to a ninth embodiment mode of the present invention.

FIG. 27 is a flow chart for describing information processing operation executed by the information processing system of the ninth embodiment mode.

FIG. 28 is a block diagram for indicating an information processing system according to a tenth embodiment mode of the present invention.

FIG. 29 is a flow chart for describing information processing operation executed by the information processing system of the tenth embodiment mode.

FIG. 30 is a flow chart for describing information processing operation executed by the information processing system of the tenth embodiment mode.

### DESCRIPTION OF THE PREFERRED EMBODIMENTS

Referring now to drawings, a description is made of embodiment modes of the present invention. It should be understood that in the below-mentioned embodiment modes, a description will be made of an information processing system and an information processing method, which are capable of initially initiating the information processing system under normal and safety conditions by avoiding an occurrence of a failure block and by correcting a bit error when the system is initially initiated from a nonvolatile storage device such as a NAND type flash memory and the like. The nonvolatile storage device has a certain possibility that failure blocks may occur in which data cannot be correctly read/written under congenital and postnatal environments, and further has some possibilities that bit errors may occur due to a long term use. When such bit errors occur, data values held in the nonvolatile storage devices are changed.

### First Embodiment Mode

FIG. 1 is a block diagram for indicating an information processing system 1 of a first embodiment mode of the present invention. As shown in FIG. 1, the information processing system 1 of the first embodiment mode is equipped with a CPU 101, a first nonvolatile storage device 110 which stores thereinto a first program group 111, a second volatile storage device 120, and a third nonvolatile storage device 130 which stores thereinto a second program 131. It should be understood that the CPU 101 and the third storage device 130 are provided within an LSI 100.

FIG. 2 is a diagram for representing an arranging example as to programs which are stored in the first storage device 110. As shown in FIG. 2, first programs 112, 113, 114 corresponding to such programs having the same contents have been stored in different blocks as to the first program group 111 within the first storage device 110.

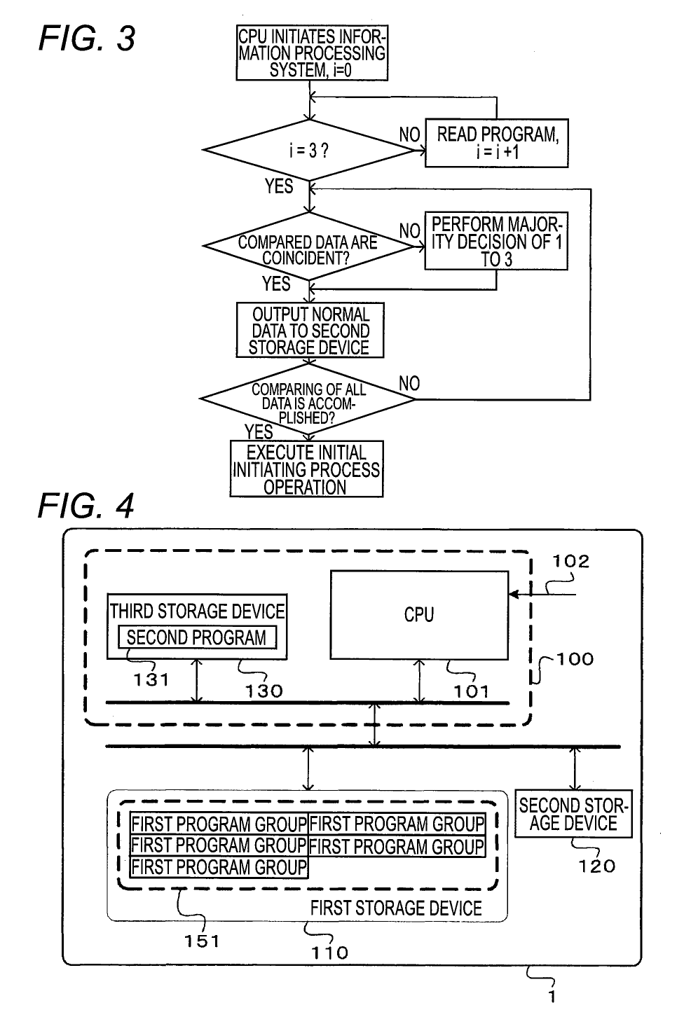

FIG. 3 is a flow chart for describing process operations of the CPU 101 related to a system initial initiation of the first embodiment mode. It should also be noted that an expression “majority judging number” implies a total number of programs which are used in a majority judgement. In the first embodiment mode, the “majority judging number” has been set to 3.

The CPU 101 accesses the third storage apparatus 130 by releasing a system reset 102 so as to execute a second program 131. Next, the CPU 101 reads out the first program group 111 from the first storage device 110, and then, transfers the read first program group 111 to the second storage device 120. Next, the CPU 101 compares the contents of the first programs 112 to 114 contained in the first program group 111 with each other. It should also be noted that the above-described comparing operations are carried out in the unit of 1, 2, 4, 8 bytes, and the like. As a result of the comparing operations, in such a case that incoincident data contents are present, the CPU 101 performs a majority decision, and then, judges a larger number of coincident data contents as normal data. The CPU 101 rewrites such data which are judged as the normal data in the second storage device 120. When the CPU 101 compares all of the contents of the first program group 111 with each other, the CPU 101 accesses the second storage device 120 in which the data judged as the normal data have been rewritten so as to execute an initial initiation of the system.

### Second Embodiment Mode

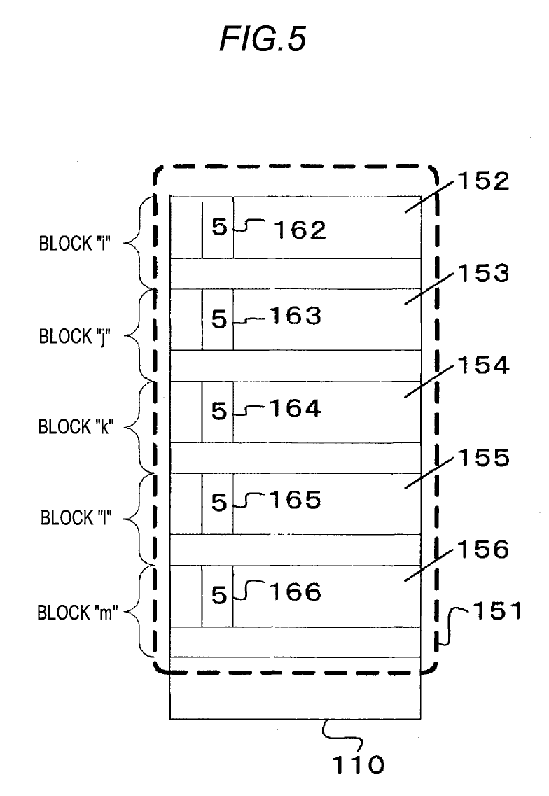

FIG. 4 is a block diagram for indicating an information processing system 1 of a second embodiment mode of the present invention. A first program group 151 containing first programs whose total number is larger than an initial value of the majority judging number has been stored in the first storage device 110. FIG. 5 is a diagram for showing an arranging example of programs stored in the first storage device 110. As the first program group 151, first groups 152 to 156 corresponding to such programs having the same contents have been stored. Parameters 162 to 166 indicative of majority judging numbers have been stored in the first programs 152 to 156 respectively. It should also be noted that in the second embodiment mode, the majority judging numbers are changed.

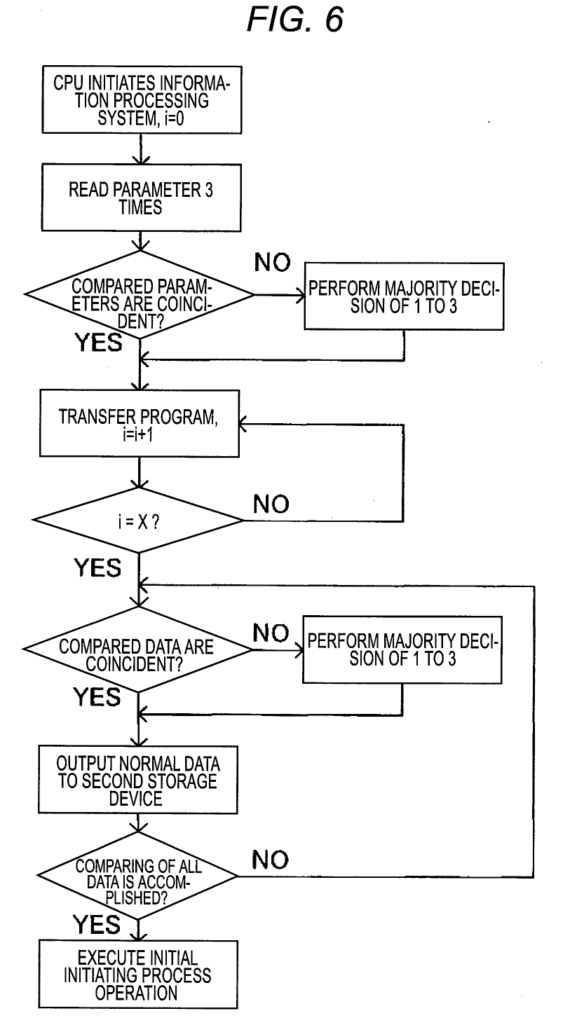

FIG. 6 is a flow chart for describing process operations of the CPU 101 related to a system initial initiation of the second embodiment mode. It should also be noted that the initial value of the majority judging number is set to, for example, 3, and is changed to 5 in the second embodiment mode.

The CPU 101 accesses the third storage apparatus 130 by releasing a system reset 102 so as to execute a second program 131. Next, the CPU 101 reads out the first program group 151 from the first storage device 110, and then, compares the read first program group 151 with the parameters 162 to 164. In the case that the first program group 151 is made coincident with a parameter, the CPU 101 defines a number indicated by the parameter as the majority judging number. To the contrary, in the case that the first program group 151 is not made coincident with parameters, the CPU 101 determines a majority judging number by performing the majority decision.

The CPU 101 transfers the first programs 152 to 156 to the second storage device 120 in accordance with the majority judging number. Next, the CPU 101 compares the contents of the first programs 152 to 156 with each other. It should also be noted that the above-described comparing operations are carried out in the unit of 1, 2, 4, 8 bytes, and the like. As a result of the comparing operations, in such a case that incoincident data contents are present, the CPU 101 performs a majority decision, and then, judges a larger number of coincident data contents as normal data. The CPU 101 rewrites such data which are judged as the normal data in the second storage device 120. When the CPU 101 compares all of the contents of the first program group 111 with each other, the CPU 101 accesses the second storage device 120 in which the data judged as the normal data have been rewritten so as to execute an initial initiation of the information processing system 1.

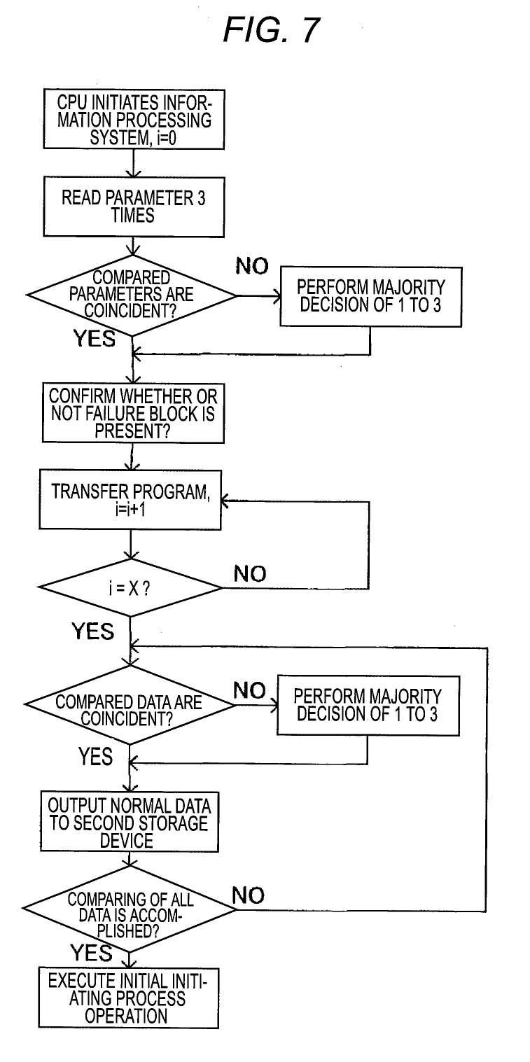

FIG. 7 is a flow chart for describing process operations of the CPU 101 when a failure block is present in the flow chart shown in FIG. 6. As indicated in FIG. 7, in such a case that the failure block is present in the first program group 151 stored in the first storage apparatus 110, the CPU 101 does not transfer data from the first storage device 110 to the second storage device 120. Moreover, when failure blocks are present, the CPU 101 defines such a number as a majority judging number, which is obtained by subtracting a total occurrence number of the failure blocks from the majority judging number.

### Third Embodiment Mode

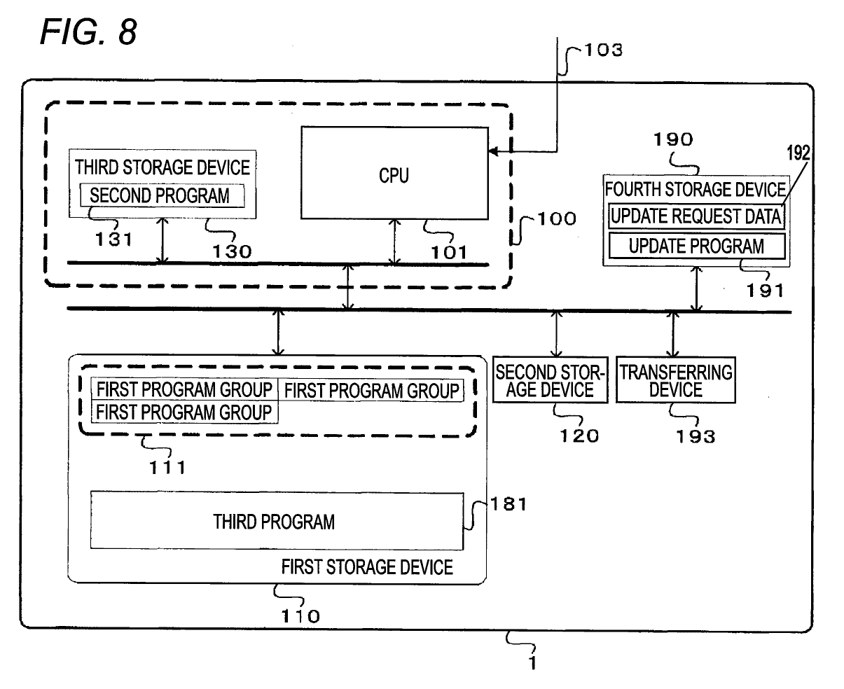

FIG. 8 is a block diagram for indicating an information processing system 1 of a third embodiment mode of the present invention. In the third embodiment mode, a first program group is updated. As indicated in FIG. 8, the information processing system 1 of the third embodiment mode is equipped with a CPU 101; a first storage device 110 for storing thereinto the first program group 111 and a third program 181 which is provided in order to execute an updating process operation; a second storage device 120; a third storage device 130 for storing thereinto a second program 131; a fourth storage device 190 for storing thereinto an update program 191 and update request data 192; and also, a transferring device 193.

As a triggering subject for updating the first program group 111, there are a program update request 103 issued from an external source outside the information processing system 1, and update request data 192 stored in the fourth storage apparatus 190. Also, the transferring device 193 has a function capable of reading out data from the fourth storage device 190 so as to transfer the read data to the second storage device 120. Further, the transferring device 193 has another function capable of reading out data from the second storage device 120 so as to transfer the read data to the first storage device 110.

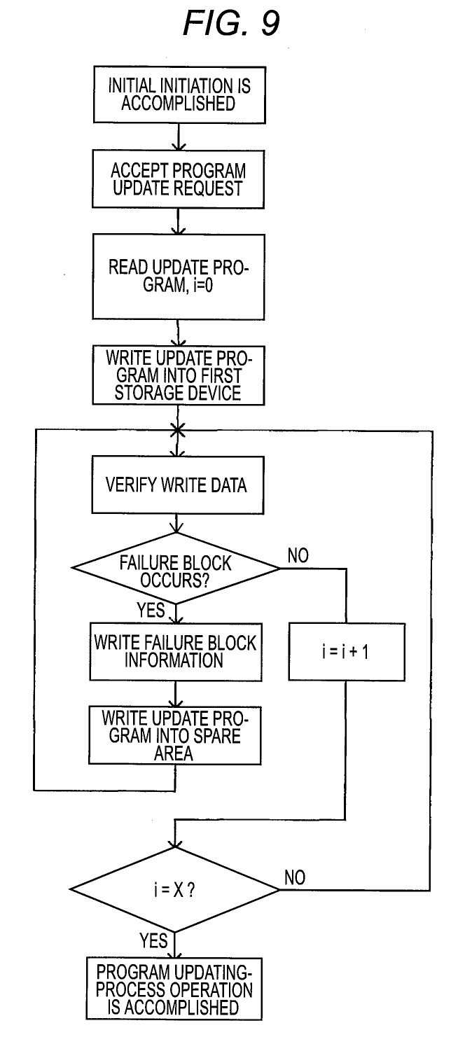

FIG. 9 is a flow chart for describing process operations of the CPU 101 when the CPU 101 updates the first program group 111. When the CPU 101 detects either the program update request 103 or the update request data 192, the CPU 101 executes an updating process operation with respect to the first program group 111. The CPU 101 reads out the update program 191 from the fourth storage device 190, and then, transfers the read update program 191 to the first storage device 110. At this time, the update program 191 may be alternatively transferred via the second storage device 120 to the first storage device 120. Alternatively, updating operation of the update program 191 may be carried out by the transferring device 193.

The CPU 101 verifies whether or not the data transferred to the first storage device 110 has been written under normal condition. At this time, in such a case that the block where the data has been written is brought into a failure block, the CPU 101 writes failure block information in this failure block, and rewrites a program into a spare area. At this time, the CPU 101 similarly performs write verification. When the CPU 101 accomplishes writing operations of a plurality of programs whose total number is equal to the majority judging number, the CPU 101 accomplishes the program updating process operation.

Also, in such a case that while the CPU 101 executes the initial initiating sequence of the information processing system 1 shown in FIG. 3, FIG. 6, or FIG. 7, a data incoincident event occurs when a data comparing operation is carried out, the CPU 101 executes an overwriting operation of the first program group 111 stored in the first storage device 110 by employing such a program stored in the second storage device 120, which could succeed in the initial initiation after the initial initiation could succeed.

### Fourth Embodiment Mode

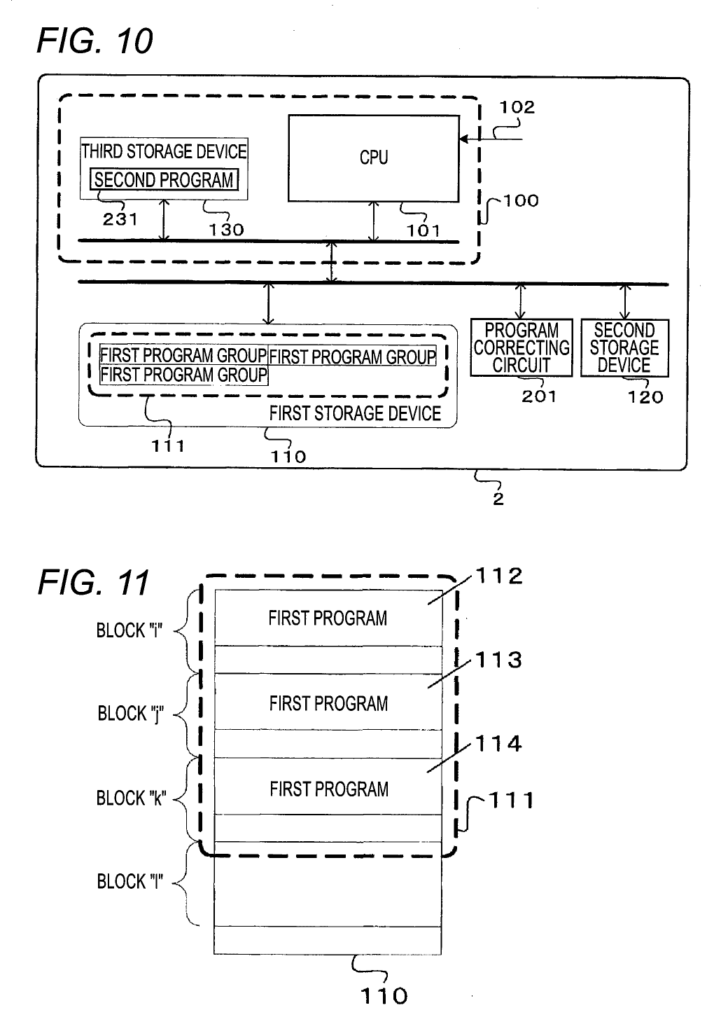

FIG. 10 is a block diagram for indicating an information processing system 2 of a fourth embodiment mode of the present invention. As indicated in FIG. 10, the information processing system 2 of the fourth embodiment mode is equipped with a CPU 101, a first storage device 110 for storing thereinto the first program group 111; a second storage device 120, a third storage device 130 for storing thereinto a second program 231, and also, a program correcting circuit 201. The program correcting circuit 201 checks a content of the first process group 111, and if an error occurs, then the program correcting circuit 201 corrects the erroneous program. It should be noted that both the CPU 101 and the third storage device 130 are provided inside an LSI 100.

FIG. 11 is a diagram for representing an arranging example as to programs which are stored in the first storage device 110. As shown in FIG. 11, first programs 112, 113, 114 corresponding to such programs having the same contents have been stored in different blocks as the first program group 111 within the first storage device 110.

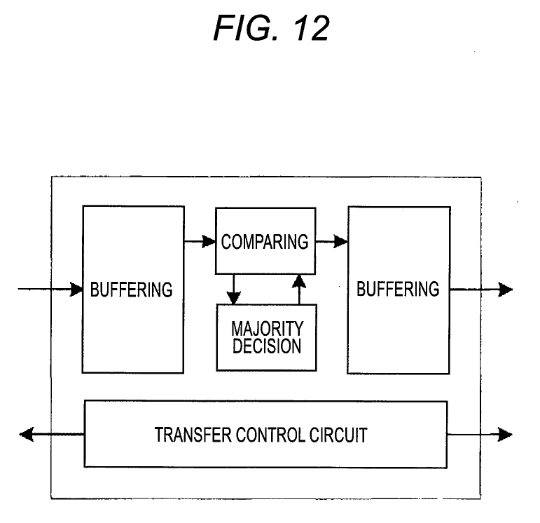

FIG. 12 is a block diagram for showing the program correcting circuit 201. The program correcting circuit 201 mainly has a comparing function of data, a correcting function of data based upon a majority decision, and a transfer controlling function of data. Also, the program correcting circuit 201 can perform a data transferring control operation and can change a majority judging number in response to an instruction issued from the CPU 101.

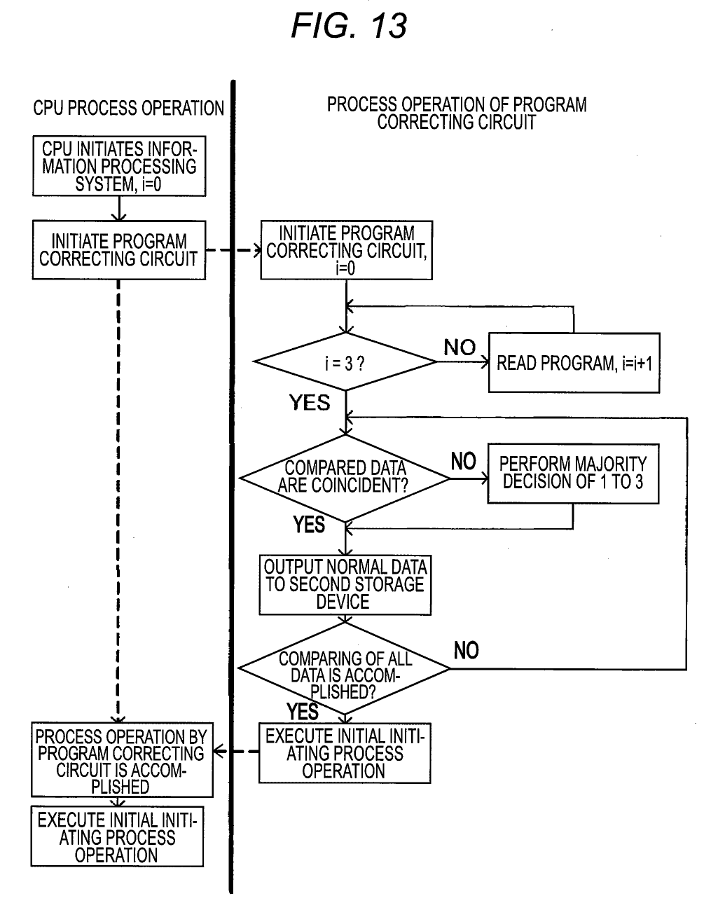

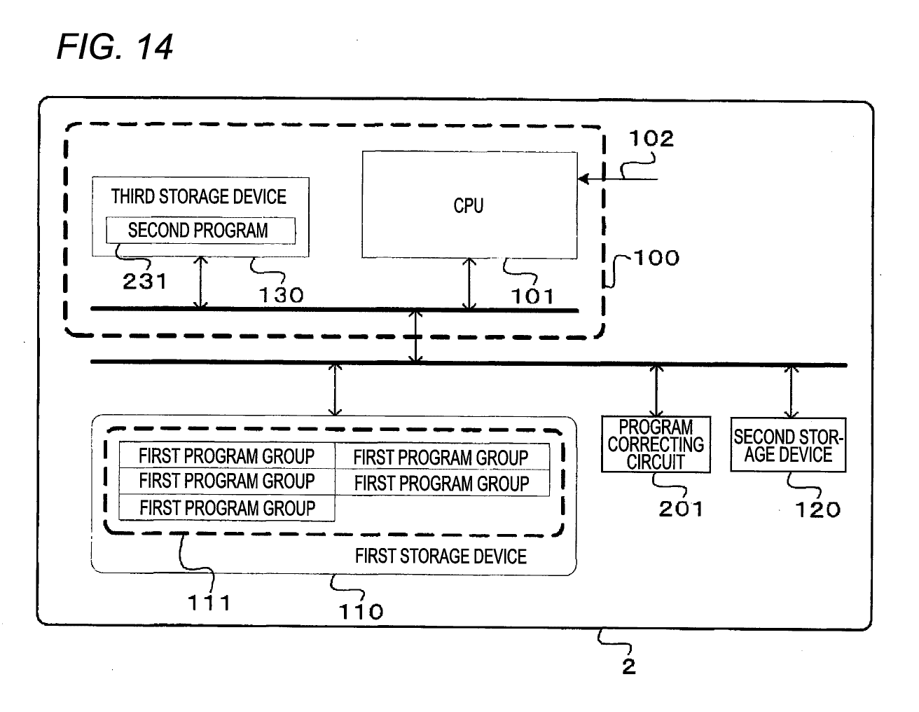

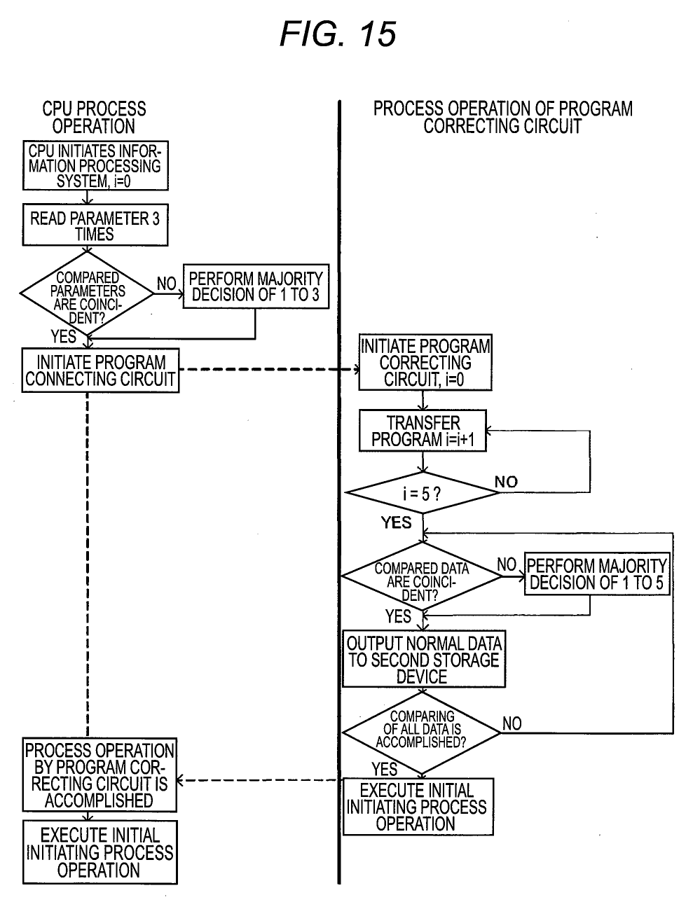

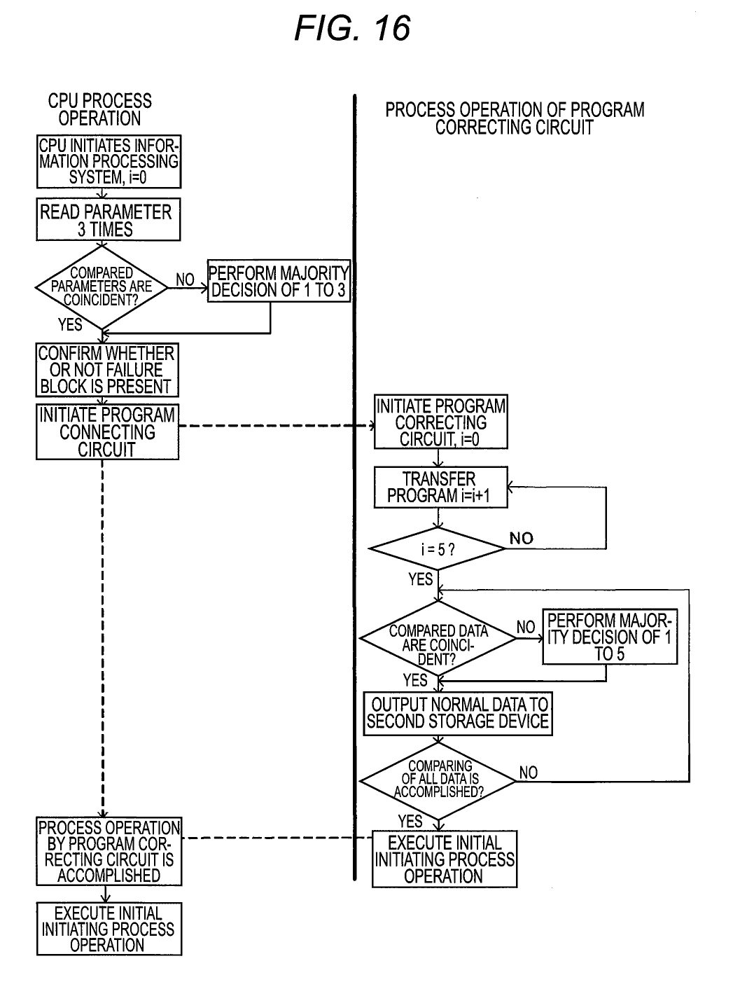

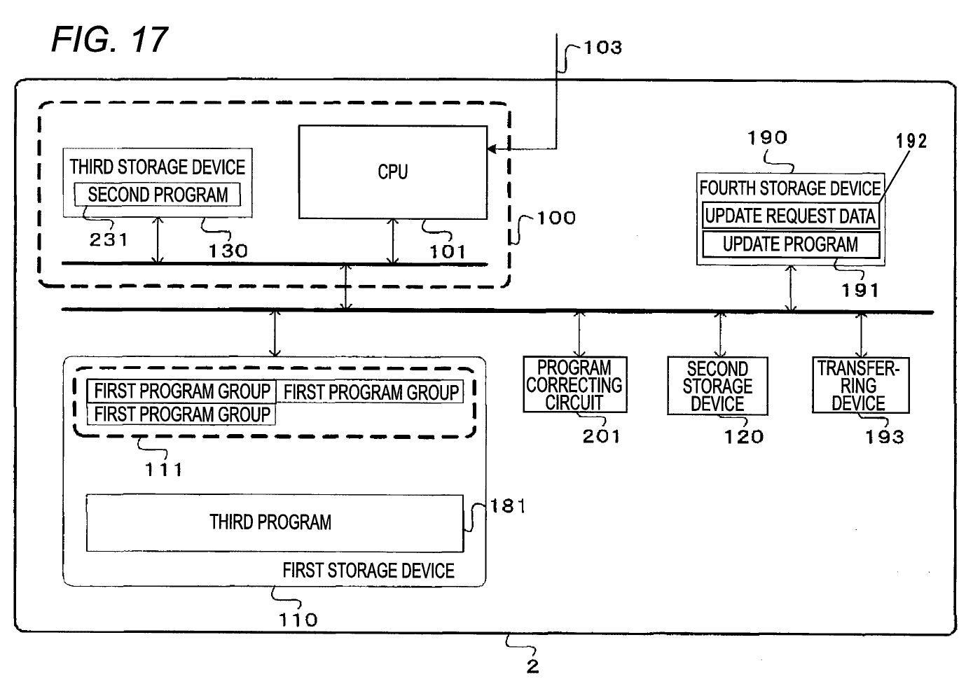

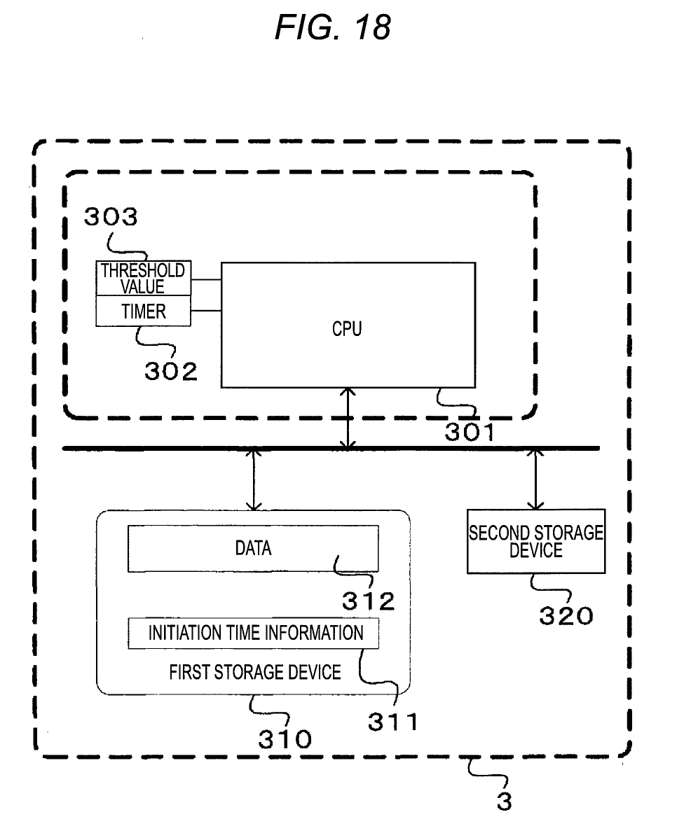

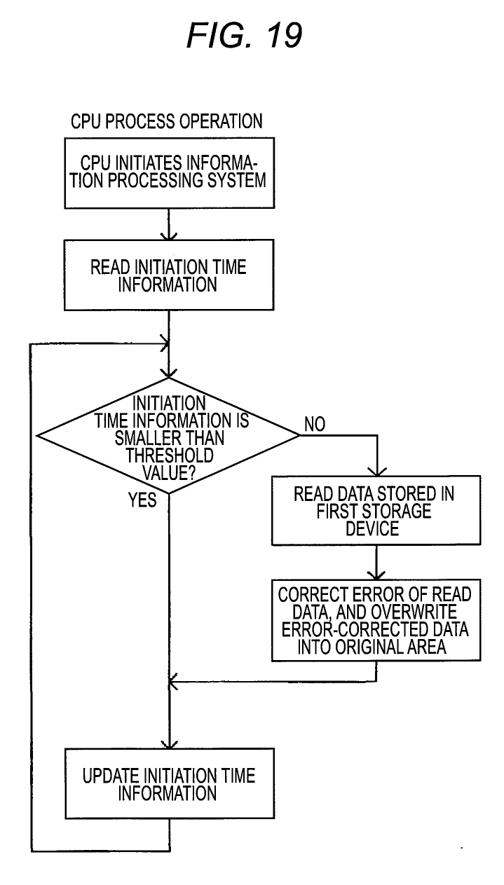

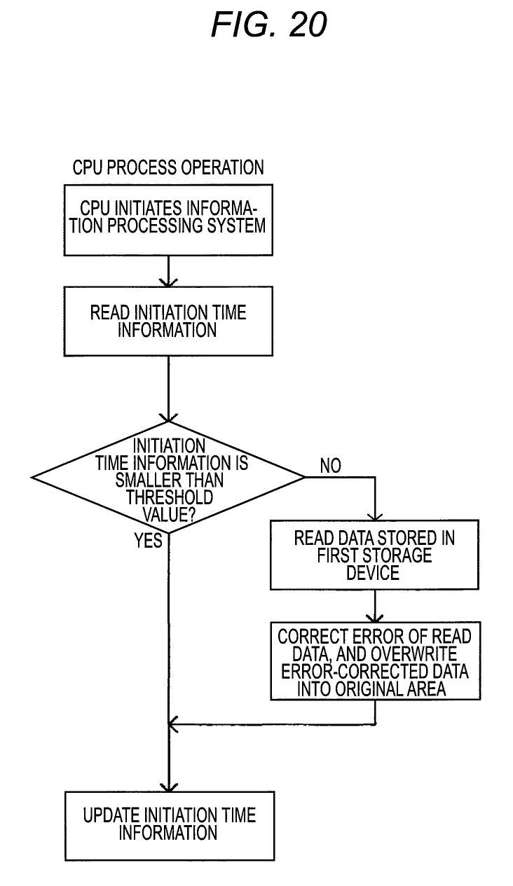

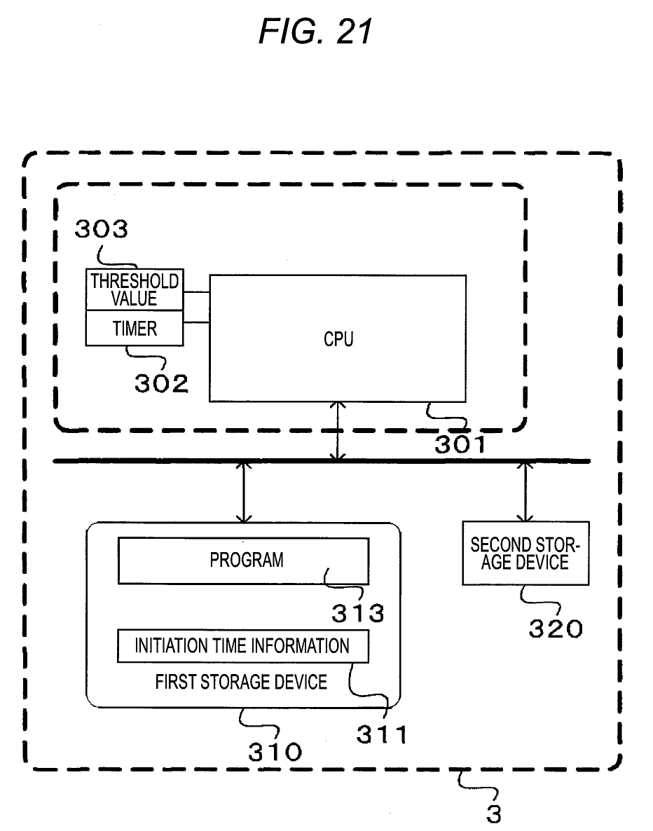

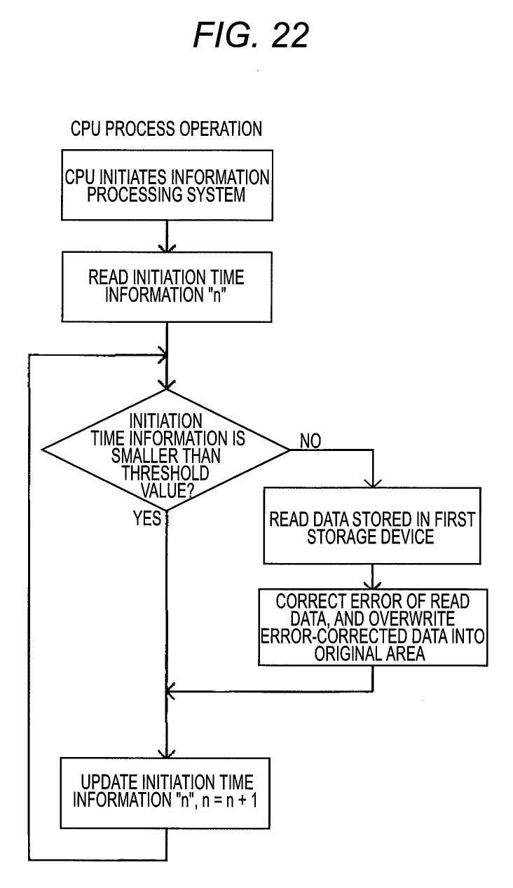

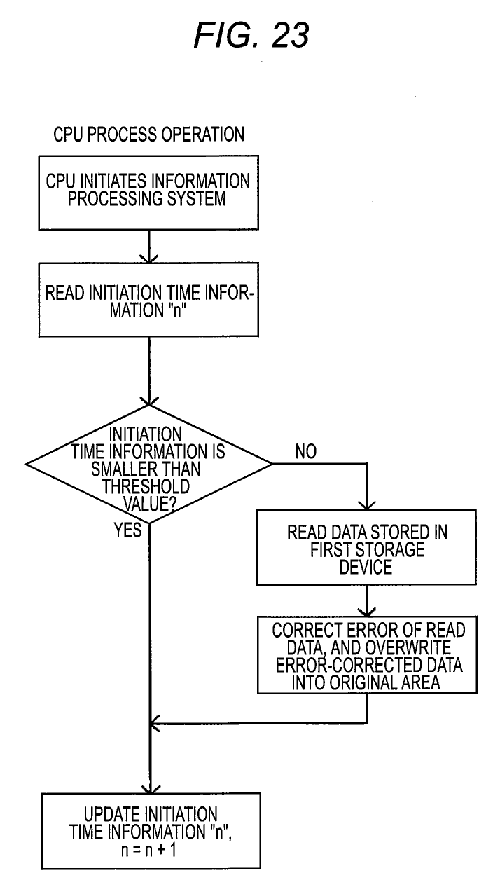

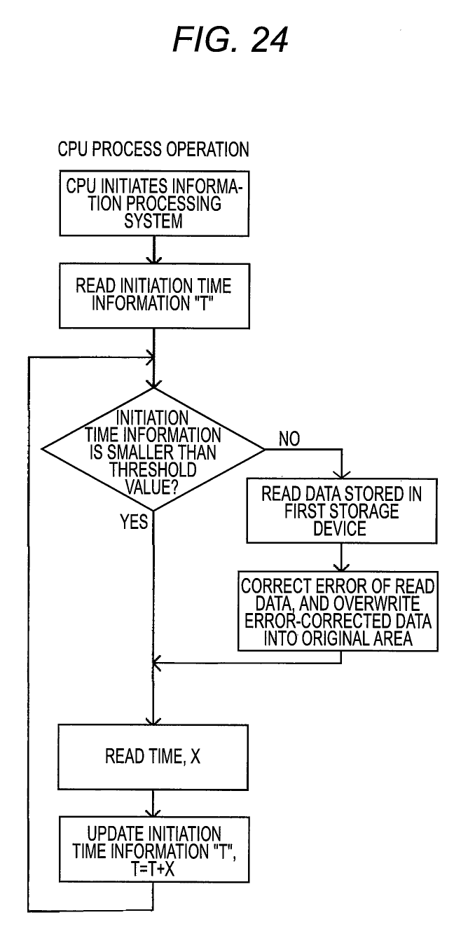

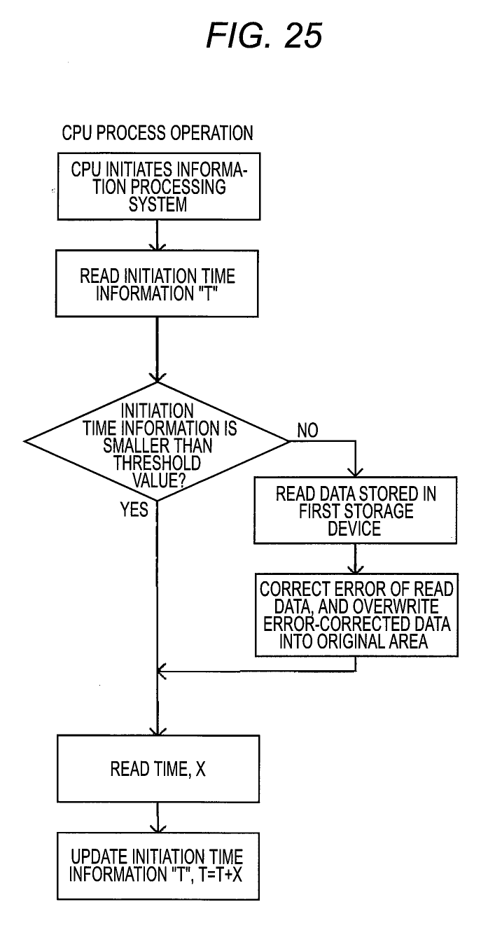

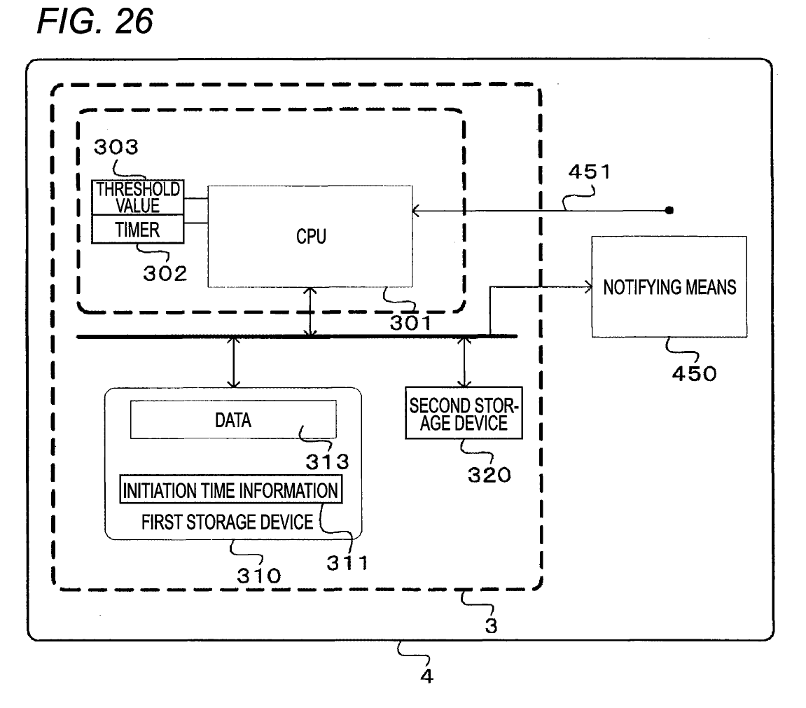

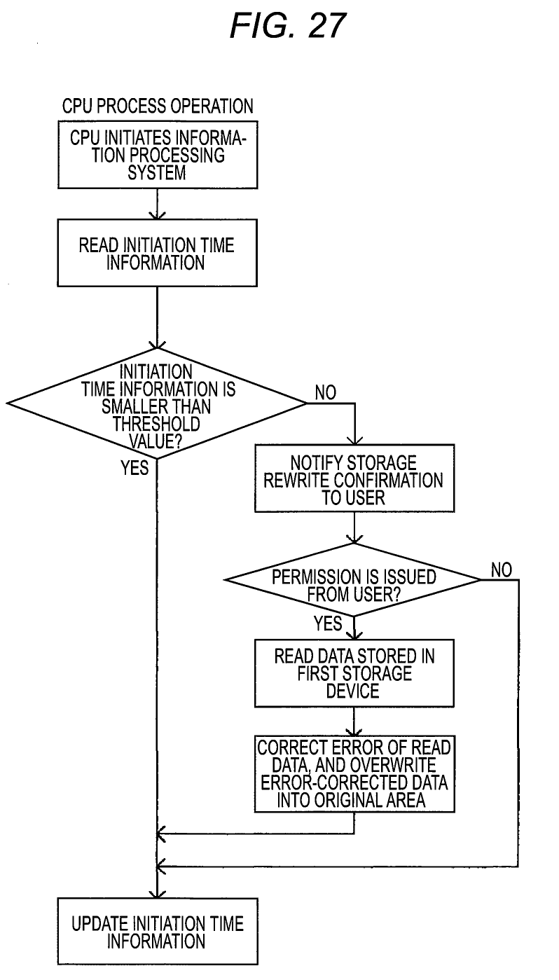

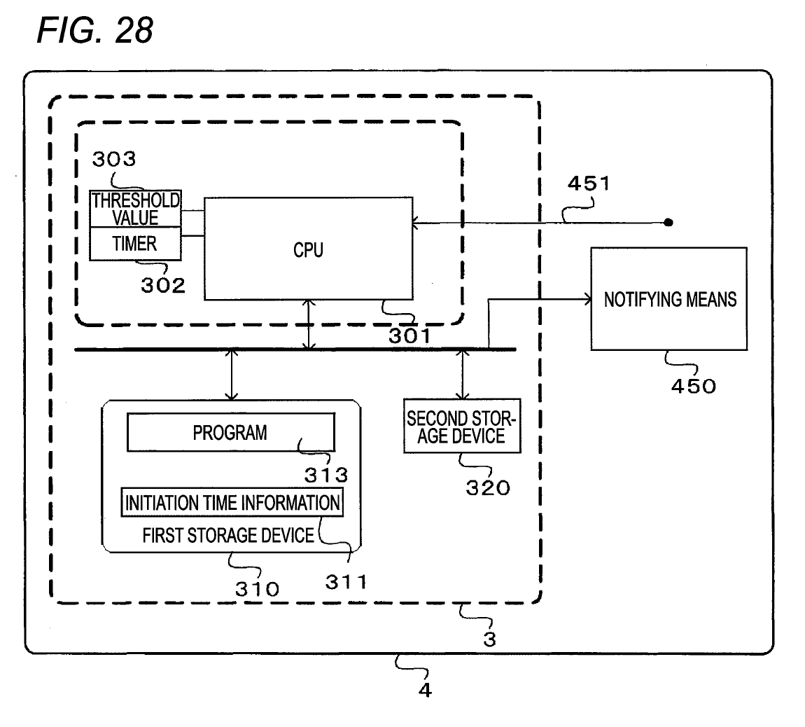

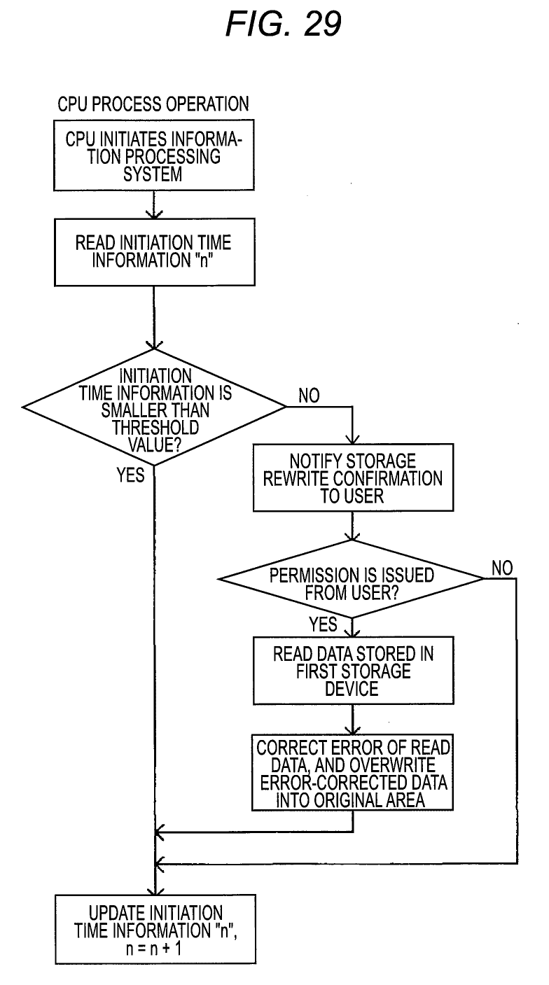

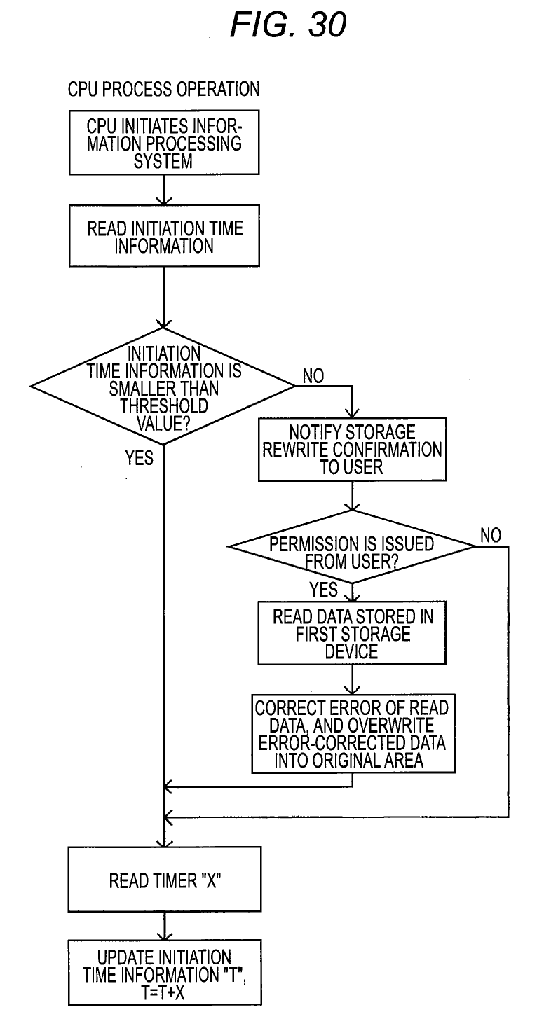

FIG. 13 is a flow chart for describing respective process operations of the CPU 101 and the program correcting circuit 201 related to a system initial initiation of the fourth embodiment mode. It should also be noted that in the fourth embodiment mode, the majority judging number has been set to 3.

The CPU 101 accesses the third storage device 130 by releasing the system reset 102 so as to execute a second program 231. Next, the CPU 101 initiates the program correcting circuit 201. The program correcting circuit 201 reads out the first program group 111 from the first storage device 110, and then, transfers the read first program group 111 to the second storage device 120. Next, the program correcting circuit 201 compares the contents of the first programs 112 to 114 contained in the first program group 111 with each other. As a result of the comparing operations, in such a case that incoincident data contents are present, the program correcting circuit 201 performs a majority decision, and then, judges a larger number of coincident data contents as normal data. The program correcting circuit 201 rewrites such data which are judged as the normal data in the second storage device 120. When the program correcting circuit 201 compares all of the contents of the first program group 111 with each other, the CPU 101 accesses the second storage device 120 in which the data judged as the normal data have been rewritten so as to execute an initial initiation of the information processing system 2.

### Fifth Embodiment Mode

FIG. 14 is a block diagram for indicating an information processing system 2 of a fifth embodiment mode of the present invention. The information processing system 2 of the fifth embodiment mode is similar to that of the fourth embodiment mode except that a first program group 151 containing a plurality of first programs whose total number is larger than an initial value of a majority judging number has been stored in the first storage device 110. It should be understood that also in this fifth embodiment mode, the majority judging number is changed.

FIG. 15 is a flow chart for describing respective process operations of the CPU 101 and the program correcting circuit 201 related to a system initial initiation of the fifth embodiment mode. It should also be noted that in the fifth embodiment mode, the initial value of the majority judging number is set to, for example, 3, and is changed to 5.

The CPU 101 accesses the third storage device 130 by releasing the system reset 102 so as to execute a second program 231. Next, the CPU 101 reads out the first program group 151 from the first storage apparatus 110, and then, compares parameters 162 to 164 with each other. When these parameters are coincident with each other, the CPU 101 determines a number indicated by the coincident parameters as the majority judging number, whereas when these parameters are not coincident with each other, the CPU 101 determines the majority judging number based upon a majority decision.

Next, the CPU 101 initiates the program correcting circuit 201. At this time, the CPU 101 sets the majority judging number to the program correcting circuit 201, and a data transferring control operation etc. The program correcting circuit 201 transfers the first programs 152 to 156 contained in the first program group 151 to the second storage device 120. Next, the program correcting circuit 201 compares the contents of the first programs 152 to 156 with each other. As a result of the comparing operations, in such a case that incoincident data contents are present, the program correcting circuit 201 performs a majority decision, and then, judges a larger number of coincident data contents as normal data. The program correcting circuit 201 rewrites such data which are judged as the normal data in the second storage device 120. When the program correcting circuit 201 compares all of the contents of the first program group 151 with each other, the program correcting circuit 201 notifies a completion of the data transfer operation to the CPU 101. The CPU 101 accesses the second storage device 120 in which the data judged as the normal data have been rewritten so as to execute an initial initiation of the system.

FIG. 16 is a flow chart for describing respective process operations of the CPU 101 and the program correcting circuit 201 when a failure block is present in the flow chart shown in FIG. 15. As indicated in FIG. 16, in such a case that a failure block is present in the first program group 151 stored in the first storage device 110, the program correcting circuit 201 does not perform transferring/setting operations of such a program corresponding to the failure block. Moreover, when a failure block is present, the CPU 101 sets such a number as the majority judging number to the program correcting circuit 201, while this number is calculated by subtracting an occurrence number of the failure blocks from the majority judging number.

### Sixth Embodiment Mode

FIG. 17 is a block diagram for indicating an information processing system 2 of a sixth embodiment mode of the present invention. The information processing system 2 of the sixth embodiment mode is equipped with the program correcting circuit 201 explained in the fourth embodiment mode in addition to the structural elements provided in the information processing system 1 of the third embodiment mode.

Contents of a process operation by the CPU 101 when the CPU 101 updates the first program group 111 are similar to those described in the third embodiment mode with reference to FIG. 9. In such a case that while the CPU 101 executes the system initial initiating sequence indicated in FIG. 13, FIG. 15, or FIG. 16, a data incoincident event occurs when the CPU 101 compares the data with each other, the CPU 101 overwrites the first program group 111 of the first storage device 110 by employing such a program which could succeed in the initial initiation on the second storage device 120 after the system initial initiation could succeed.

### Seventh Embodiment Mode

FIG. 18 is a block diagram for indicating an information processing system 3 of a seventh embodiment mode of the present invention. As shown in FIG. 18, the information processing system 3 of the seventh embodiment mode is equipped with a CPU 301; a timer 302; a threshold value 303 which is used so as to be compared with an initiation time; a first storage device 310 for storing thereinto initiation time information 311; and a second storage device 320.

FIG. 19 is a flow chart for describing an information processing operation executed by the information processing system 3 of the seventh embodiment mode. The CPU 301 reads out the initiation time information 311 from the first storage device 310 after the information processing system 3 is initiated. Next, the CPU 301 compares the initiation time information 311 with the threshold value 303 contained in the CPU 301. In the case that the initiation time information 311 is smaller than the threshold value 303, the CPU 301 is advanced to the next process operation without executing any process operation. In the case that the initiation time information 311 is larger than the threshold value 303, the CPU 301 reads out data 312 which has been stored in the first storage device 310. In addition, the CPU 301 executes an error correcting process operation with respect to the read data 312, and then, rewrites the error-corrected data in the same storage area on the first storage device 310 where the data 312 has been stored, and thereafter, is advanced to the next process operation. Next, the CPU 301 updates the initiation time information 311, and then, rewrites the updated initiation time information 311 in the first storage device 310. At this time, in such a case that the initiation time information 311 exceeds the threshold value 303, the CPU 301 repeatedly executes the above-described processing operation.

FIG. 20 is a flow chart for describing an information processing operation executed by the information processing system 3 of the seventh embodiment mode, which is different from that of the sixth embodiment mode. Although the flow chart shown in FIG. 20 is the substantially same as the flow chart indicated in FIG. 19, process operations thereof after the initiation time information 311 has been updated are different from those of the flow chart shown in FIG. 19. That is, the CPU 301 updates the initiation time information 311, and then, rewrites the updated initiation time information 311 to the first storage device 310. At this time, even if the initiation time information 311 exceeds the threshold value 303, then the CPU 301 accomplishes the process sequence.

### Eighth Embodiment Mode

FIG. 21 is a block diagram for indicating an information processing system 3 according to an eighth embodiment mode of the present invention. In the eighth embodiment mode, a first storage device 310 stores thereinto a program 313 which is executed by a CPU 301 instead of the data 312 represented in FIG. 18.

In the information processing operation executed by the information processing system 3 of the eighth embodiment mode, as represented in FIG. 22 and FIG. 23, while initiation time information 311 shown in FIG. 21 is defined as an initiation time “n”, the CPU 301 executes a process operation of n=n+1 every time the CPU 301 performs an initial initiation. Alternatively, as shown in FIG. 24 and FIG. 25, while the initiation time information 311 indicated in FIG. 21 may be defined as an accumulated value “T” of “X (namely, measurement time of initiation time)” measured by the timer 302, the CPU 301 may execute a process operation of T=T+X.

### Ninth Embodiment Mode

FIG. 26 is a block diagram for indicating an information processing system 4 of a ninth embodiment mode of the present invention. As shown in FIG. 26, in the information processing system 4 of the ninth embodiment mode, notifying means 450 for a user has been additionally employed with respect to the information processing system 3 of the seventh embodiment mode shown in FIG. 18. Also, permission information 451 is entered from the user to the CPU 301.

FIG. 27 is a flow chart for describing an information processing operation executed by the information processing system 4 of the ninth embodiment mode. The CPU 301 reads out the initiation time information 311 from the first storage device 310 after the information processing system 4 is initiated. Next, the CPU 301 compares the initiation time information 311 with a threshold value 303 contained in the CPU 301. In the case that the initiation time information 311 is smaller than the threshold value 303, the CPU 301 is advanced to the next process operation without executing any process operation. In the case that the initiation time information 311 is larger than the threshold value 303, the CPU 301 requests the user via the notifying means 450 so as to confirm that the contents of the first storage device 310 is rewritten. When the CPU 301 accepts the permission information 451 from the user, the CPU 301 reads out the data 312 which has been stored in the first storage device 310. In addition, the CPU 301 executes an error correcting process operation with respect to the read data 312, and then, rewrites the error-corrected data in the same storage area on the first storage device 310 where the data 312 has been stored, and thereafter, is advanced to the next process operation. On the other hand, when the CPU 301 cannot accept the permission information 451 issued from the user, the CPU 301 is advanced to the next process operation without executing any process operation. Next, the CPU 301 updates the initiation time information 311, and then, rewrites the updated initiation time information 311 into the first storage device 310. At this time, in such a case that the initiation time information 311 exceeds the threshold value 303, the CPU 301 accomplishes the above-described processing sequential operation.

### Tenth Embodiment Mode

FIG. 28 is a block diagram for indicating an information processing system 4 according to a tenth embodiment mode of the present invention. In the tenth embodiment mode, a first storage device 310 stores thereinto a program 313 which is executed by a CPU 301 instead of the data 312 represented in FIG. 26.

In the information processing operation executed by the information processing system 4 of the tenth embodiment mode, as represented in FIG. 29, while initiation time information 311 shown in FIG. 28 is defined as an initiation time “n” , the CPU 301 executes a process operation of n=n+1 every time the CPU 301 performs an initial initiation. Alternatively, as shown in FIG. 30, while the initiation time information 311 indicated in FIG. 28 may be defined as an accumulated value “T” of “X (namely, measurement time of initiation time)” measured by the timer 302, the CPU 301 may execute a process operation of T=T+X.

In accordance with the information processing system and the information processing method of the above-described embodiment modes, while the first programs 111 and the duplicated first programs 111 have been stored in the first storage device 110, the respective first programs 111 and duplicated programs thereof are compared with each other, and then, the normal program is judged based upon the majority decisions. As a consequence, the initial initiation of the system can be carried out under normal condition and in safety manners. Also, since the failure block is avoided and the bit error is corrected, the system can be initially initiated in firmer manners. Also, since the bit error can be corrected in a simple manner, the information processing system and the information processing method can be properly operated even when the generation of the nonvolatile storage device is changed. In addition, the occurrence frequency of the bit errors can be suppressed, so that the initial initiating time of the system can be shortened.

The information processing system and the information processing method, according to the present invention, may be usefully employed as electronic appliances such as personal computers, portable type information appliances, portable telephones, digital cameras, digital video cameras, game machines, and digital audio appliances, which require to initially initiate systems.

What is claimed is:

1. An information processing system, comprising:
a first nonvolatile storage device in which a plurality of first programs for initiating the information processing system, and duplications of said plural first programs have been stored in blocks different from each other;
a second volatile storage device to which said plurality of first programs are transferred;
a third nonvolatile storage device into which a second program for executing said plural first programs is stored; and
a CPU (Central Processing Unit) for executing said plural first programs.

2. The information processing system as claimed in claim 1 wherein:
an instruction has been contained in said second program, while said instruction instructs that said plurality of first programs are transferred from said first storage device to said second storage device, contents of said plurality of first programs transferred to said second storage devices are compared with each other; and if the contents of said plurality of first programs are not made coincident with each other, then a normal program is judged from said plurality of first programs based upon a majority decision; and wherein:
said CPU executes the first program judged as said normal program so as to initially initiate the information processing system.

3. The information processing system as claimed in claim 2 wherein:
a judging value for determining a total number at which the contents of said plurality of first programs are compared with each other has been contained in said first program; and wherein:
said CPU executes said instruction in accordance with said judging value.

4. The information processing system as claimed in claim 2 wherein:
in a case that an area where either one of said first programs or a duplication of one of said first programs has been stored is a failure block in said first storage device, the program stored in such an area including said failure block is not employed in the comparisons of said contents of said plurality of first programs.

5. The information processing system as claimed in claim 2 wherein:
when one of said first programs is updated, an update program for one of said first programs is overwritten in the area where one of said first programs has been stored, and also, a duplication of said update program is overwritten in the area where the duplication of one of said first programs has been stored; and wherein:
in such a case that a failure block is present in the area where either one of said first programs or said duplication of one of said first programs has been stored, either said update program or the duplication of said update program is written in a previously prepared spare area of said first storage device.

6. The information processing system as claimed in claim 2 wherein:
after said CPU could succeed in an execution of said first programs, said CPU overwrites data judged as the normal data in such an area judged as an error area at a place where the content of said plurality of first programs are not made coincident with each other.

7. An information processing system comprising:
a first nonvolatile storage device in which a plurality of first programs for initiating the information processing system, and duplications of said plural first programs have been stored in blocks different from each other;
a second volatile storage device to which said plurality of first programs are transferred;
a third nonvolatile storage device into which a second program for executing said plural first programs is stored;
a CPU (Central Processing Unit) for executing said plural first programs and said second program; and
a program correcting circuit for correcting an error of said first programs.

8. The information processing system as claimed in claim 7 wherein:
said program correcting circuit compares contents of said plurality of first programs transferred to said second storage device with each other;
when the contents of said plurality of first programs are not made coincident with each other, said program correcting circuit judges a normal program among said plurality of first programs based upon a majority decision; and
said program correcting circuit rewrites such a first program judged as said normal program in said second storage device.

9. The information processing system as claimed in claim 8 wherein:
an instruction has been contained in said second program, while said instruction instructs that said plurality of first programs are transferred from said first storage device to said second storage device so as to initiate said program correcting circuit; and wherein:
said CPU executes said first program judged as the normal program by said program correcting circuit so as to initially initiate the information processing system.

10. The information processing system as claimed in claim 9 wherein:
a judging value for determining a total number at which the contents of sid plurality of first programs are compared with each other has been contained in said first programs;
said CPU executes said instruction in accordance with said judging value; and
said program correcting circuit compares the contents of said plurality of first programs with each other and judges said normal program based upon the majority decision in accordance with said judging value.

11. The information processing system as claimed in claim 9 wherein:
in such a case that an area where either one of said first programs or a duplication of one of said first programs has been stored is a failure block in said first storage device, the program stored in such an area including said failure block is not employed in the comparisons of said contents of said plurality of first programs.

12. The information processing system as claimed in claim 9 wherein:
when one of said first programs is updated, an update program for one of said first programs is overwritten in the area where one of said first programs has been stored, and also, a duplication of said update program is overwritten in the area where the duplication of one of said first programs has been stored; and wherein:
in such a case that a failure block is present in the area where either one of said first programs or said duplication of one of said first programs has been stored, either said update program or the duplication of said update program is written in a previously prepared spare area of said first storage device.

13. The information processing system as claimed in claim 9 wherein:
after said CPU could succeed in an execution of said first programs, said CPU overwrites data judged as normal data in such an area judged as an error area at a place where the content of said plurality of first programs are not made coincident with each other.

14. The information processing method which is executed by an information processing system comprising a CPU (Central Processing Unit) and a nonvolatile storage device for storing thereinto initiation time information of the information processing system; wherein:
said CPU updates said initiation time information while said information processing system is initiated; and wherein:
when said initiation time exceeds a designated threshold value, said CPU overwrites the same contents stored in said nonvolatile storage device.

15. The information processing method as claimed in claim 14 wherein:
the content which has been stored in said nonvolatile storage device is a program which is executed by said CPU.

16. The information processing method as claimed in claim 14 wherein:
said initiation time information is initiating time information of the information processing system.

17. The information processing method as claimed in claim 14 wherein:
said initiation time information is an actual time during which the information processing system is being initiated.

18. An information processing method of an information processing system comprising:
a CPU (Central Processing Unit);
a nonvolatile storage device for storing thereinto initiation time information of the information processing system; and
a notifying unit for notifying an execution of refreshing a program with respect to a user who uses the information processing system; wherein:
in such a case that said user issues a permission with respect to said notification notified by said notifying unit, said CPU updates said initiation time information while said information processing system is initiated; and wherein:
when said initiation time exceeds a designated threshold value, said CPU overwrites the same contents stored in said nonvolatile storage device.

19. The information processing method as claimed in claim 18 wherein:
the content which has been stored in said nonvolatile storage device is a program which is executed by said CPU.

20. The information processing method as claimed in claim 18 wherein:
said initiation time information is initiating time information of the information processing system.

21. The information processing method as claimed in claim 18 wherein:
said initiation time information is an actual time during which the information processing system is being initiated.
